(19) United States
(12) Patent Application Publication
(10) Pub. No.: US 2013/0305830 A1
(43) Pub. Date: Nov. 21, 2013

(54) PRESSURE SENSOR ELEMENT

(71) Applicants: Kyou Takahashi, Morioka (JP); Haruyuki Endo, Morioka (JP); Katsuhiko Fukui, Iwate-gun (JP); Sou Matsumoto, Iwate-gun (JP)

(72) Inventors: Kyou Takahashi, Morioka (JP); Haruyuki Endo, Morioka (JP); Katsuhiko Fukui, Iwate-gun (JP); Sou Matsumoto, Iwate-gun (JP)

(73) Assignee: MIKUNI CORPORATION, Chiyoda-ku, Tokyo (JP)

(21) Appl. No.: 13/982,962

(22) PCT Filed: Jan. 30, 2012
(86) PCT No.: PCT/JP2012/052021

§ 371 Date: Jul. 31, 2013

(30) Foreign Application Priority Data
Jan. 31, 2011 (JP) 2011-018715

(51) Int. Cl. G01L 9/08

(52) U.S. Cl. CPC G01L 9/085
USPC 73/708

(57) ABSTRACT

[Problem] To provide a pressure sensor element which is not greatly decreased in the resistance due to temperature increase.

[Solution] A pressure sensor element which is provided with a piezoelectric element and a high-resistance material film. The piezoelectric element has an upper surface and a lower surface. The high-resistance material film at least partially covers the upper surface and/or the lower surface. The electrical resistance of the high-resistance material film is higher than the electrical resistance of the piezoelectric element.

### TECHNICAL FIELD

This invention relates to a pressure sensor element which is used in a high-temperature environment, for example, the pressure sensor element attached to a glow plug of an internal combustion engine.

### BACKGROUND ART

Temperature drift is known as a problem which is caused when a piezoelectric element is used in a high-temperature environment. For example, as described in Patent Document 1, the temperature drift is occasionally caused from a decrease of electrical resistance of the piezoelectric element due to an increase of temperature. According to Patent Document 1, the temperature drift is prevented when the pressure sensor element is formed with a piezoelectric element made of a monocrystalline material represented by a particular formula. For example, each of Patent Document 2 and Patent Document 3 also discloses a technique relating to temperature correction. According to Patent Document 2, unlike Patent Document 1, the electrical resistance of the piezoelectric element is considered to increase due to the increase of temperature. Accordingly, the piezoelectric element of Patent Document 2 is attached with a temperature correction member having an electrical resistance which decreases as the temperature increases so that the temperature correction is done. In order to avoid the influence of the electrostatic capacity of the piezoelectric element which increases as the temperature increases, the piezoelectric element of Patent Document 3 is attached with a temperature compensation element having electrostatic capacity which decreases as the temperature increases.

### PRIOR ART DOCUMENTS

### Patent Document(s)

Patent Document 1: JPA 2010-185852

Patent Document 2: JP U H4-115042

Patent Document 3: JP A H 8-50072

### SUMMARY OF INVENTION

### Technical Problem

The solution described in each of Patent Documents 1 to 3 is not generally applicable to the various existing piezoelectric elements each having the problem of the temperature drift.

It is therefore an object of the present invention to provide a pressure sensor element comprising a highly versatile structure which is capable of overcoming the problem of the temperature drift.

### Solution to Problem

One aspect of the present invention provides a pressure sensor element comprises a piezoelectric element and a high-resistance material film. The piezoelectric element has an upper surface and a lower surface. The high-resistance material film covers, at least in part, at least one of the upper surface and the lower surface. The high-resistance material film has an electrical resistance larger than an electrical resistance of the piezoelectric element.

### Advantageous Effects of Invention

According to the present invention, the piezoelectric element is covered with the high-resistance material film so that it is possible to prevent an electrical resistance of the pressure sensor element from largely decreasing due to an increase of temperature.

An appreciation of the objectives of the present invention and a more complete understanding of its structure may be had by studying the following description of the preferred embodiment and by referring to the accompanying drawings.

### BRIEF DESCRIPTION OF DRAWINGS

FIG. 1 is a side view schematically showing a structure of a pressure sensor element according to an embodiment of the present invention.

FIG. 2 is a side view schematically showing a structure of another pressure sensor element according to the embodiment of the present invention.

FIG. 3 is a collection of schematic diagram and graphs for showing an effect due to a decrease of electrical resistance of the pressure sensor element, wherein an output voltage of the pressure sensor element is measured under a state where the pressure sensor element is connected to a charge amplifier.

FIG. 4 is a graph showing an electrical resistance of each of an existing pressure sensor element and the pressure sensor element according to the embodiment of the present invention.

FIG. 5 is a graph showing a sensitivity of each of the existing pressure sensor element and the pressure sensor element according to the embodiment of the present invention.

FIG. 6 is a graph showing an electrical resistance change caused by a temperature change of each of the existing pressure sensor element and the pressure sensor element according to the embodiment of the present invention.

FIG. 7 is a graph showing a time-dependent change of an amount of electric charges of a drift current which is generated under the normal temperature in each of the existing pressure sensor element and the pressure sensor element according to the embodiment of the present invention.

FIG. 8 is a graph showing a time-dependent change of an amount of electric charges of another drift current which is generated under the temperature of 80° C. in each of the existing pressure sensor element and the pressure sensor element according to the embodiment of the present invention.

### DESCRIPTION OF EMBODIMENTS

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

Hereinafter, an embodiment of the present invention (hereinafter, referred to as “the present embodiment”) is described in detail with reference to Figures. When directions such as “upper” and “lower” are used in the following description, each of the directions does not define a direction in use but only shows a relative direction in each of Figures.

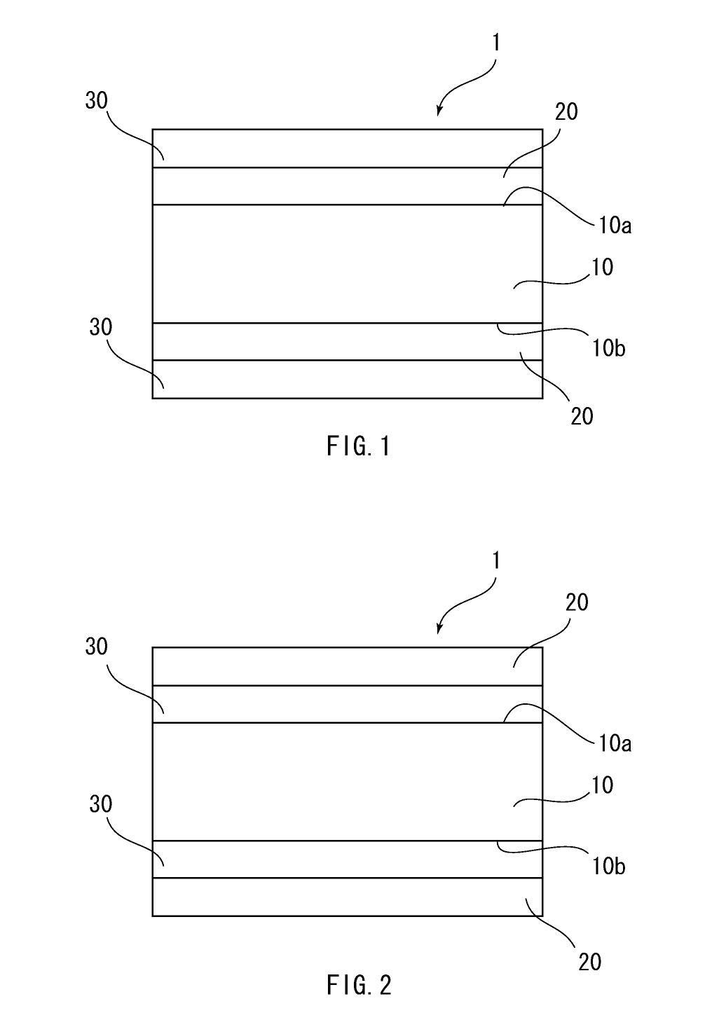

A pressure sensor element 1 according to the present embodiment is configured to be used in a high-temperature environment. For example, the pressure sensor element 1 is attached to a glow plug of an internal combustion engine and is used therein. As shown in FIGS. 1 and 2, the pressure sensor element 1 comprises a piezoelectric element 10 made of a piezoelectric material and a high-resistance material film 20 made of a high electrical resistance material such as a dielectric material. The pressure sensor element 1 is formed to have a plate-like shape as a whole. In detail, the piezoelectric element 10 has an upper surface 10a and a lower surface 10b which have a relationship between the front and the back in a polarization direction. The whole upper surface 10a and the whole lower surface 10b are covered with the high-resistance material film 20. The illustrated pressure sensor element 1 further comprises electrodes (electrode films) 30 for extracting electric charges from the piezoelectric element 10. When the pressure sensor element 1 is formed with the electrodes 30, the high-resistance material film 20 may be formed to be sandwiched, at least in part, between the piezoelectric element 10 and the electrodes 30 (see FIG. 1). Alternatively, the electrodes 30 may be formed to be sandwiched, at least in part, between the piezoelectric element 10 and the high-resistance material film 20 (see FIG. 2). Moreover, as understood from FIG. 1, the electrodes 30 can be attached to the pressure sensor element 1 as necessary without being formed upon a production of the pressure sensor element 1. In the pressure sensor element 1 configured as described above, the piezoelectric element 10 is electrically connected with the high-resistance material film 20 in series. Accordingly, the pressure sensor element 1 can keep a high electrical resistance as a whole even if an electrical resistance of the piezoelectric element 10 decreases under the high-temperature environment.

The piezoelectric element 10 according to the present embodiment is made of a monocrystalline zinc oxide. Piezoelectric materials are roughly classified into monocrystalline materials and polycrystalline materials. The monocrystalline materials include a zinc oxide, a rock crystal, a langasite crystal, a gallium phosphate, a lithium niobate, a lithium tantalate, etc. The polycrystalline materials include a lead zirconate titanate, a barium titanate, etc. Although the material of the piezoelectric element 10 is not limited to the aforementioned monocrystalline zinc oxide, a material having a high electrical resistance is preferred for high-accurate pressure detection under the high-temperature environment.

The high-resistance material film 20 should be formed from the high electrical resistance material having an electrical resistance higher (i.e. larger) than the electrical resistance of the piezoelectric element 10 in a temperature range where the pressure sensor element 1 is used. The high electrical resistance material may be either an organic substance or an inorganic substance. Moreover, the high electrical resistance material may have any chemical composition. However, considering that the polarization of the piezoelectric element 10 polarizes the high electrical resistance material to act on the upper side and lower side electrodes 30, it is preferred to use the dielectric material that does not have pyroelectricity, for example, a glass material or a ceramic material. Specifically, one of SiO₂, Al₂O₃, AlN, MgO, SiAlON and SiN, or a mixture of two or more of them may be used as the high electrical resistance material to be formed in one, two or more layers (i.e. multilayer). The high-resistance material film 20 according to the present embodiment is made of SiO₂ having amorphous structure.

The electrode 30 may be formed from either a single metal film or two or more (i.e. multi) metal films layered over one another. For example, one of Pt, Ti, Au, Cr, W, Pd, Ni, Ag, Al, Ta and Mo may be used as a material.

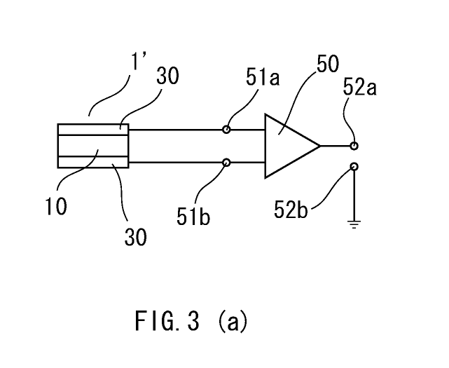

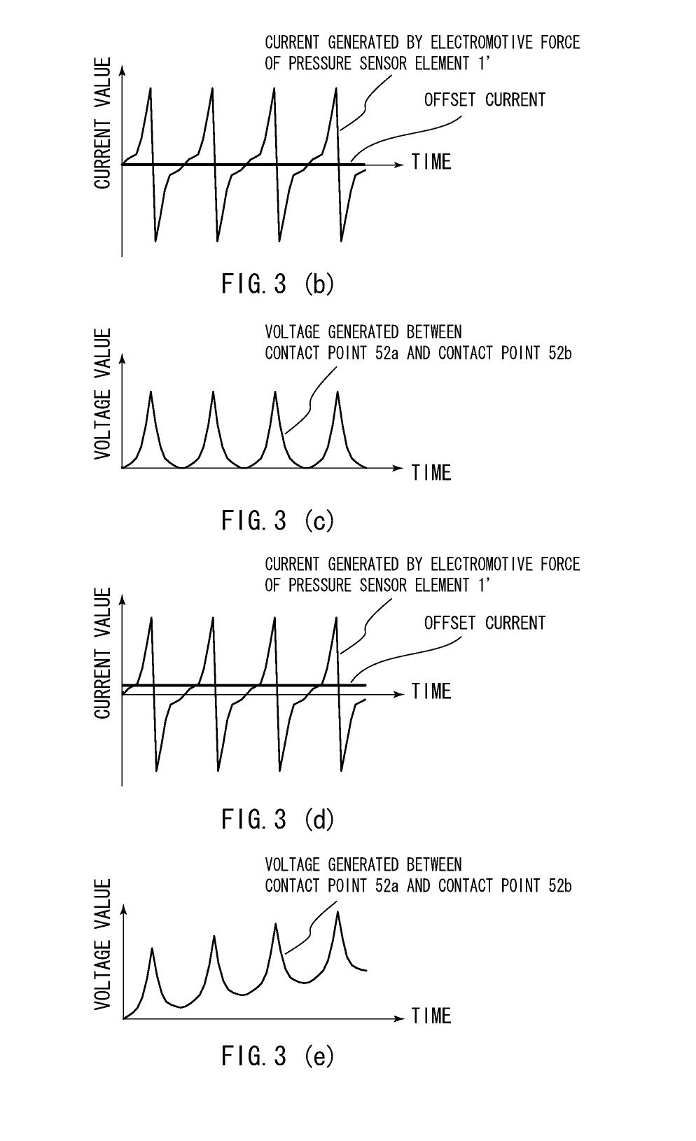

As shown in FIG. 3(a), an existing pressure sensor element 1′ includes the electrodes 30 formed on an upper side and a lower side in the polarization direction of the piezoelectric element 10, respectively, but does not include the high-resistance material film 20. When the upper and lower surfaces of this pressure sensor element 1′ are applied with a pressure, polarized electric charges are generated in proportion to the pressure. Accordingly, the applied pressure can be measured by measuring the polarized electric charges. Specifically, the pressure sensor element 1′ is connected to a charge amplifier 50. The charge amplifier 50 integrates and amplifies a current generated between a contact point 51a and a contact point 51b by an electromotive force of the pressure sensor element 1′. A voltage, which is generated between a contact point 52a and a contact point 52b by the integral amplification, is measured as a pressure signal. However, when the measurement is thus performed, in fact, an offset voltage which is generated at an input terminal of the charge amplifier 50 supplies the pressure sensor element 1′ with an offset current as an additional factor. Accordingly, the charge amplifier 50 integrates and amplifies the sum of the current due to the pressure and the offset current. This offset current has an amount depending on the electrical resistance of the pressure sensor element 1′ and the offset voltage. The electrical resistance of the pressure sensor element 1′ depends on a temperature. In detail, the electrical resistance of the pressure sensor element 1′ typically decreases as the temperature increases. Accordingly, as described below, the accuracy of the measurement is degraded, for example, when the offset voltage having a predetermined voltage value is generated and the electrical resistance of the pressure sensor element 1′ changes depending on the temperature. As shown in FIG. 3(b), since the electrical resistance of the pressure sensor element 1′ is large under a room temperature, the offset current is negligibly small. Accordingly, only the current generated by the electromotive force of the pressure sensor element 1′ is practically integrated and amplified so that the voltage generated between the contact point 52a and the contact point 52b of the charge amplifier 50 is observed as shown in FIG. 3(c). On the other hand, as shown in FIG. 3(d), since the electrical resistance of the pressure sensor element 1′ decreases under a high temperature, the offset current increases. Accordingly, the integral amplification of the offset current generates a drift effect so that the voltage is generated between the contact point 52a and the contact point 52b of the charge amplifier 50 as shown in FIG. 3(e). As describe above, the accuracy of the measurement of the existing pressure sensor element 1′ is degraded under the high temperature environment.

On the other hand, since the pressure sensor element 1 according to the present embodiment comprises the high-resistance material film 20, the pressure sensor element 1 has the high electrical resistance even under the high temperature environment so that the drift is hardly generated. Accordingly, the pressure sensor element 1 according to the present embodiment can keep the high accuracy of the measurement even under the high temperature environment. In other words, the high-resistance material film 20 is required to have the electrical resistance such that the drift is not practically generated in the temperature range where the pressure sensor element 1 is used. Specifically, the pressure sensor element 1 comprising the high-resistance material film 20 is required to have the electrical resistance of equal to or more than 1×10¹¹Ω (i.e. combined resistance of the piezoelectric element 10 and the high-resistance material film 20 is required to be equal to or more than 1×10¹¹Ω) under the environment of the temperature between 400° C. and 500° C. In order to satisfy the aforementioned conditions, the electrical resistance of the high-resistance material film 20 is preferred to be equal to or more than 1×10¹¹Ω under an ordinary temperature. SiO₂ having amorphous structure satisfies the aforementioned conditions and is preferable for the material of the high-resistance material film 20.

In order to prevent the drift, the high-resistance material film 20 preferably has a thick thickness to make its electrical resistance high. However, in order to transfer the electric charges generated in the piezoelectric element 10 to the electrode 30 without loss, it is preferable that the thickness is thin. Moreover, when the thickness of the high-resistance material film 20 is excessively thin (specifically, when being thinner than 0.1 μm), it is difficult to cover a roughness (irregularities) of the surface of the piezoelectric element 10. On the other hand, when the thickness of the high-resistance material film 20 is excessively thick (specifically, when being thicker than 10 μm), the high-resistance material film 20 might crack. Moreover, since the high-resistance material film 20 is connected with the piezoelectric element 10 in series to serve as a capacitance material layer and a stress-buffering layer, the improvement of the sensitivity of the piezoelectric element and the increase of the electric resistance of the element have a trade-off relation therebetween. Considering the above described various conditions, when the high-resistance material film 20 is formed from SiO₂ having amorphous structure and an electrical resistivity of 1×10¹¹ Ω·cm to 1×10¹⁸ Ω·cm, both inclusive (preferably, 1×10¹⁴ Ω·cm to 1×10¹⁸ Ω·cm, both inclusive), it is preferable that the thickness of the high-resistance material film 20 is 0.1 μm to 10 μm, both inclusive.

The high-resistance material film 20 according to the present embodiment can be formed by dipping the piezoelectric element 10 in a glass coat liquid made of a high-resistance material, followed by drying the piezoelectric element 10. The high-resistance material film 20 may be also formed via one of a sol-gel process, a printing process, a sputtering process, an evaporation process and a chemical vapor deposition (CVD) process. The high-resistance material film 20 may be formed on only one of the upper surface 10a and the lower surface 10b of the piezoelectric element 10. Moreover, the high-resistance material film 20 may cover not the whole upper surface 10a (lower surface 10b) but a part of the upper surface 10a (lower surface 10b). Moreover, the high-resistance material film 20 may be formed not only on the upper surface 10a and the lower surface 10b but also on a side surface. Moreover, the thickness of the high-resistance material film 20 on the upper surface 10a and the thickness of the high-resistance material film 20 on the lower surface 10b may be either same as each other or different from each other. In other words, it is enough that the high-resistance material film 20 covers, at least in part, at least one of the upper surface 10a and the lower surface 10b.

### EXAMPLES

Hereinafter, the present invention is described in further detail by the use of specific examples.

### Example

At first, a plate-like piezoelectric element was made of a monocrystalline zinc oxide. The piezoelectric element had an upper surface and a lower surface each having a size of 2 mm×2 mm. The piezoelectric element had a thickness of 0.5 mm. The piezoelectric element was polarized in an up-down direction.

Then, the whole piezoelectric element was coated with SiO₂ film having amorphous structure. Specifically, the piezoelectric element was dipped in a glass coating agent (SSL-SD2000, Produced by Exousia Inc.) and dried under a room temperature after being taken out. After being dried, the piezoelectric element was placed in an oven to be heated by 1 hour under 250° C. The upper surface and the lower surface of the piezoelectric element after heating are covered with the SiO₂ film (high-resistance material film) having a thickness of 2 μm. Finally, the upper side and the lower side of the high-resistance material film were attached with electrodes. Example of a pressure sensor element was obtained via the aforementioned process. In this Example, the high-resistance material film was formed on the piezoelectric element having a chip form. However, it is possible to divide a wafer made of a piezoelectric material into chips via dicing method or the like after the high-resistance material film is formed on the wafer.

### Comparative Example

Similar to Example, a plate-like piezoelectric element was made of a monocrystalline zinc oxide. The piezoelectric element had an upper surface and a lower surface each having a size of 2 mm×2 mm. The piezoelectric element had a thickness of 0.5 mm. The piezoelectric element was polarized in the up-down direction. The upper side and the lower side of the piezoelectric element were attached with electrodes so that Comparative Example of a pressure sensor element was obtained. The pressure sensor element of Comparative Example comprised no high-resistance material film. In other words, the pressure sensor element of Comparative Example was an existing pressure sensor element.

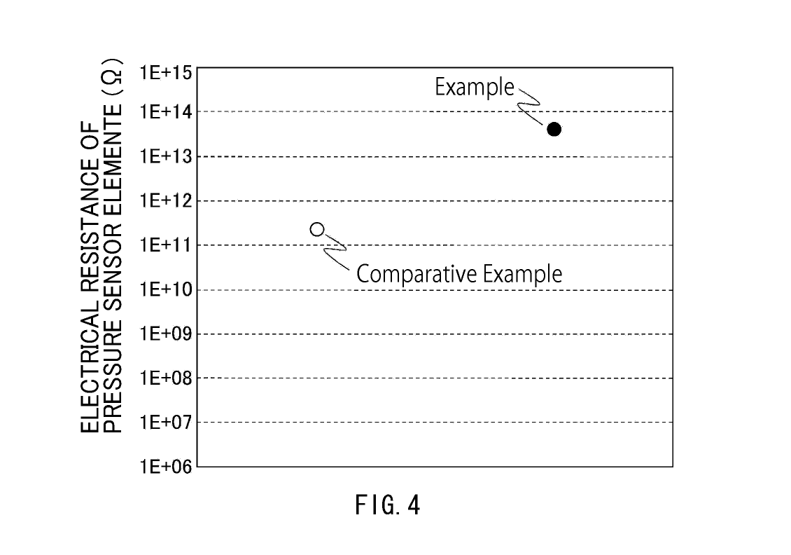

An electrical resistance under the normal temperature of each of the pressure sensor element of Example and the pressure sensor element of Comparative Example was measured. As shown in FIG. 4, the pressure sensor element of Example comprising the high-resistance material film had the electrical resistance greatly improved in comparison with the pressure sensor element of Comparative Example.

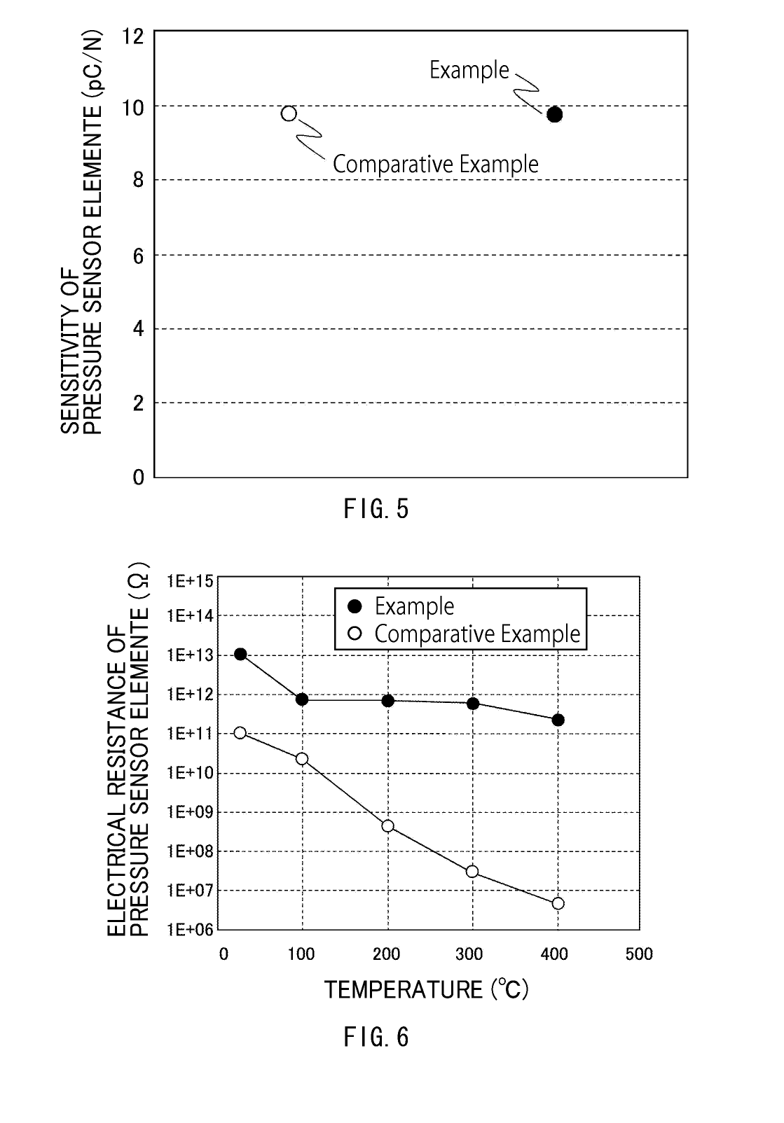

A sensitivity of each of the pressure sensor element of Example and the pressure sensor element of Comparative Example was measured. The sensitivity was measured by measuring an amount of electric charges generated when the pressure sensor element was directly applied with a load. As shown in FIG. 5, the pressure sensor element of Example and the pressure sensor element of Comparative Example had the same sensitivity. As can be seen from the result of the measurement of the electrical resistances and the sensitivities, the formed high-resistance material film improved the electrical resistance without largely affecting the sensitivity of the pressure sensor element.

The electrical resistance of each of the pressure sensor element of Example and the pressure sensor element of Comparative Example was measured under a state where the temperature was changed in a range from the room temperature to 400° C. As shown in FIG. 6, the effect of the present invention was more remarkable as the temperature was higher. For example, under the temperature of 400° C., the electrical resistance of the pressure sensor element of Comparative Example greatly decreased while the electrical resistance of the pressure sensor element of Example slightly decreased. In this case, the electrical resistance of the SiO₂ film, which was the high-resistance material film of the present Example, was particularly larger than the electrical resistance of the monocrystalline zinc oxide. More specifically, it was conceivable that the electrical resistance of the high-resistance material film of the present Example was nearly equal to the electrical resistance shown by the pressure sensor element of the present Example. Although the temperature was repeatedly raised and lowered between the room temperature and 400° C. for this measurement, neither the piezoelectric element nor the high-resistance material film of the pressure sensor element of Example cracked or peeled off. Accordingly, it was understood that the pressure sensor element according to the present invention had high reliability even in temperature cyclic loading.

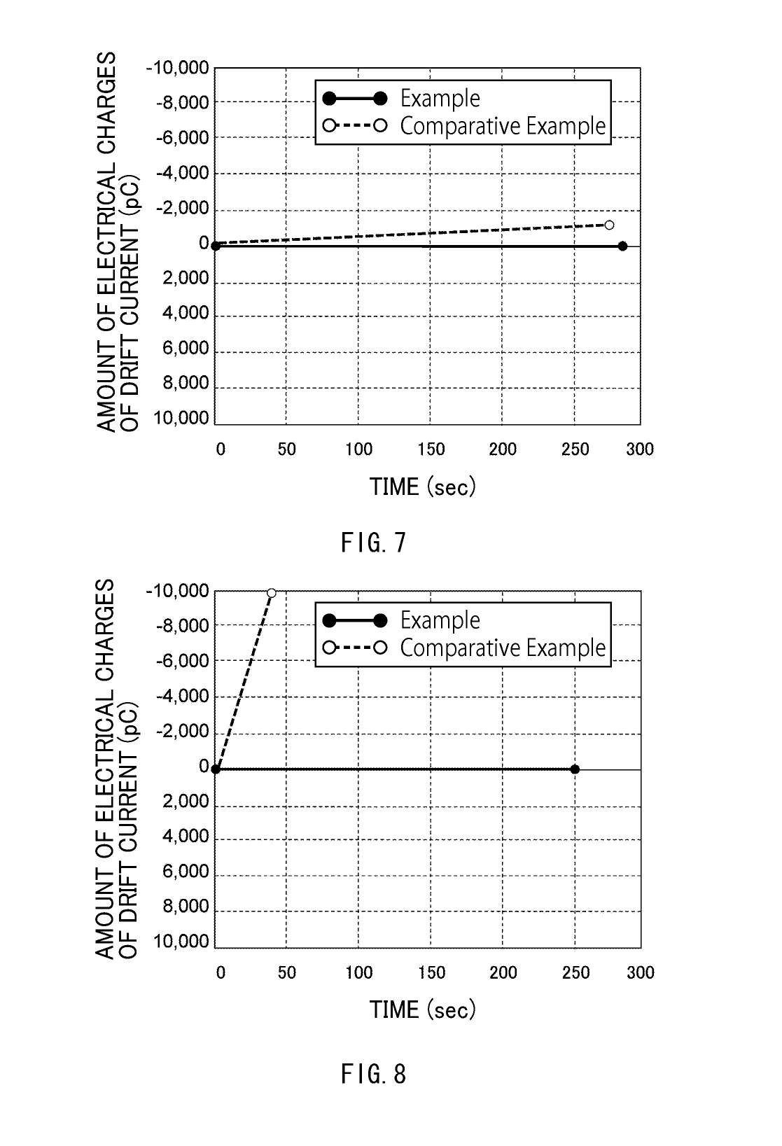

Drift suppressing effect according to the present invention was tested. Specifically, as shown in FIG. 3(a), each of the pressure sensor element of Example and the pressure sensor element of Comparative Example was connected to a charge amplifier. Then, an output voltage between the contact point 52a and the contact point 52b was measured under a state where the pressure sensor element was applied with no pressure. An amount of electric charges of a drift current was obtained from the measured output voltage. As shown in FIG. 7, under the room temperature, the amount of the electric charges of the pressure sensor element of Comparative Example increased (the drift becomes larger) over time. On the other hand, the drift was not observed about the pressure sensor element of Example. Moreover, as shown in FIG. 8, under the temperature of 80° C., the drift of the pressure sensor element of Comparative Example was greatly larger in comparison with the result of the measurement under the room temperature. On the other hand, the drift of the pressure sensor element of Example was very slight.

The amount of the electric charges of each of the drift currents measured under the room temperature and 80° C. is shown in Table 1. As shown in Table 1, in comparison with the pressure sensor element of Comparative Example, the amount of the electric charges of the pressure sensor element of Example was about 1/100 under the room temperature and about 1/1000 under the temperature of 80° C.

TABLE 1

| | | | Example/ |
|---|---|---|---|
| Temperature under | Comparative | | Comparative |
| measurement environment | Example | Example | Example |
| room temperature | −3.7 pC/sec | −0.036 pC/sec | about 1/100 |
| 80° C. | −270 pC/sec | −0.39 pC/sec | about 1/1000 |

The present application is based on a Japanese patent application of JP2011-18715 filed before the Japan Patent Office on Jan. 31, 2011, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

### REFERENCE SIGNS LIST

1, 1′ pressure sensor element

10 piezoelectric element

10a upper surface

10b lower surface

20 high-resistance material film

30 electrode (electrode film)

50 charge amplifier

51a, 51b contact point

52a, 52b contact point

1. A pressure sensor element comprising:
a piezoelectric element having an upper surface and a lower surface; and
a high-resistance material film covering, at least in part, at least one of the upper surface and the lower surface, the high-resistance material film having an electrical resistance larger than an electrical resistance of the piezoelectric element.

2. The pressure sensor element as recited in claim 1, wherein at least one of the upper surface and the lower surface of the piezoelectric element is wholly covered with the high-resistance material film.

3. The pressure sensor element as recited in claim 1, wherein the high-resistance material film is made of a dielectric material.

4. The pressure sensor element as recited in claim 1, wherein the high-resistance material film has an electrical resistivity of 1×10¹¹ Ω·cm to 1×10¹⁸ Ω·cm, both inclusive.

5. The pressure sensor element as recited in claim 1, wherein a combined resistance of the piezoelectric element and the high-resistance material film is equal to or more than 1×10¹¹Ω.

6. The pressure sensor element as recited in claim 1, wherein:
the high-resistance material film is made of SiO₂ having amorphous structure; and
the high-resistance material film has a thickness of 0.1 μm to 10 μm, both inclusive.

7. The pressure sensor element as recited in claim 1, wherein the high-resistance material film is formed via one of a dipping process, a sol-gel process, a printing process, a sputtering process, an evaporation process and a chemical vapor deposition process.

8. The pressure sensor element as recited in claim 1, the pressure sensor element further comprising an electrode for extracting electric charges from the piezoelectric element.

9. The pressure sensor element as recited in claim 8, wherein the high-resistance material film is formed to be sandwiched, at least in part, between the piezoelectric element and the electrode.

10. The pressure sensor element as recited in claim 8, wherein:
the electrode is formed from one or more metal films; and
each of the metal films is made of one of Pt, Ti, Au, Cr, W, Pd, Ni, Ag, Al, Ta and Mo.

11. The pressure sensor element as recited in claim 1, wherein the piezoelectric element is made of a zinc oxide.
